(19) United States
(12) Patent Application Publication
(10) Pub. No.: US 2026/0036740 A1
(43) Pub. Date: Feb. 5, 2026

(54) HOLLOW CORE OPTICAL FIBER PREFORM WITH SEAL AND METHOD OF MANUFACTURING HOLLOW CORE OPTICAL FIBER THEREFROM

(71) Applicant: CORNING INCORPORATED, CORNING, NY (US)

(72) Inventors: Chams Baker, Corning, NY (US); Antoine Gaston Denis Bisson, Painted Post, NY (US); Dane Alphanso Christie, Painted Post, NY (US); Timothy Michael Gross, Painted Post, NY (US); Adam Robert Sarafian, Corning, NY (US)

(21) Appl. No.: 19/272,680

(22) Filed: Jul. 17, 2025

Related U.S. Application Data
(60) Provisional application No. 63/677,599, filed on Jul. 31, 2024.

(51) Int. Cl. G02B 6/02; C03B 37/027

(52) U.S. Cl. CPC G02B 6/02328; C03B 37/02781; G02B 6/02342; C03B 2203/16

(57) ABSTRACT

A hollow core optical fiber preform including a seal at least partially sealing one or more of a cladding opening of a cladding tube and a capillary opening of each or some of one or more capillary tubes within a cladding interior of the cladding tube. The hollow core optical fiber preform includes a seal glass composition exhibiting a seal coefficient of thermal expansion that is within ±10% of a coefficient of thermal expansion of the cladding or a coefficient of thermal expansion of the one or more capillaries. The hollow core optical fiber perform can further include one or more metal tubes extending through the seal. The metal tubes can be placed in fluid communication with one or more sources of a gas to control gas pressure within the one or more capillary tubes and the cladding interior during a draw step to control the dimensions thereof.

This application claims the benefit of priority to U.S. Provisional Patent Application Ser. No. 63/677,599 filed on Jul. 31, 2024, the content of which is relied upon and incorporated herein by reference in its entirety.

### TECHNICAL FIELD

The present disclosure pertains to a hollow core optical fiber preform and, more particularly, to a seal for a cladding opening and/or capillary opening(s) during drawing of optical fiber from the preform while controlling gas pressure within an interior of the cladding and/or capillaries.

### BACKGROUND

Optical fibers are utilized to transmit data. More particularly, a transmitter converts information into pulses of electromagnetic radiation and transmits the pulses into the optical fiber. The electromagnetic radiation transmits along the optical fiber to a receiver. The receiver re-converts the pulses of electromagnetic radiation back into information.

Optical fiber often includes a solid core through which the electromagnetic radiation moves and a cladding surrounding the solid core to maintain the electromagnetic radiation within the solid core. The cladding and the solid core exhibit different indices of refraction, and the difference causes the electromagnetic radiation to stay generally within the solid core during transmission due to total internal reflection. The solid core of the optical fiber is often formed of silica-based glass.

Transmission performance of optical fibers with a solid core can suffer from confinement loss and losses due to scattering, absorption, and bending. Imperfection in the material of the solid core can cause scattering and absorption of the electromagnetic radiation pulses that the optical fiber is transmitting. Further losses of the intensity of the electromagnetic radiation from the core into the cladding occur due to external perturbations, such as bending and stresses when optical fibers are packed and deployed in cables. Confinement losses result from leaky modes in the optical fiber. Leaky modes have evanescent fields of optical signal intensity that extend beyond the core into the cladding. Losses due to scattering, absorption, and lack of confinement reduce the power of the electromagnetic radiation pulses. Reduced power limits the ability of the receiver to convert the pulses back into information, which limits the reach of the optical fiber.

In an effort to improve the performance of optical fibers, hollow core optical fibers are under development. Hollow core optical fibers mitigate attenuation of optical signals and provide further advantages such as low non-linearity, low dispersion, and low latency. Hollow core optical fibers, as the name suggests, do not include a core of solid material. Rather, the core is a gas, such as air. Due to the absence of a solid core, it is thought that the electromagnetic radiation could transmit without as much scattering and absorption loss

In some instances, the hollow core optical fiber includes a glass cladding, which is a tube, and glass capillary tubes disposed within the glass cladding around a fiber longitudinal axis. The glass capillary tubes define an effective core radius within the glass cladding. Such hollow core optical fibers rely on anti-resonance to maintain the pulses within the effective core radius and transmit through the hollow core optical fiber with limited confinement loss.

Manufacturing a hollow core optical fiber having such components is also an area of active development. To provide anti-resonance, the glass capillary tubes should maintain their intended relative positioning and dimensions throughout a length of the hollow core optical fiber. However, maintaining the relative positioning and dimensions during manufacture is extremely difficult.

### SUMMARY

In some proposed manufacturing processes, the hollow core optical fiber is drawn from a hollow core optical fiber preform. During the draw, gas pressure within the glass capillary tubes is controlled to achieve a radius and a wall thickness as desired for the glass capillary tubes. For example, increasing the gas pressure within the glass capillary tubes during draw can stabilize the radius while draw of the hollow core optical fiber from the hollow core optical fiber preform decreases the wall thickness of the glass capillary tubes. To control the gas pressure within the glass capillary tubes, gas is introduced into one or both of (i) the glass cladding tube to control the gas pressure therein and (ii) the glass capillary tubes to control the gas pressure therein. While introducing gas into the gas capillary tubes directly controls gas pressure therein, controlling gas pressure within the glass cladding tube also controls the gas pressure within the glass capillary tubes, because the gas pressure within the glass cladding tube influences the gas pressure within the glass capillary tubes or the differential in pressure between the glass cladding tube and the glass capillary tubes. In some instances, gas is introduced into only the glass cladding tube, such as when ends of the glass capillary tubes are closed.

To introduce gas into one or more of the glass cladding tube and the glass capillary tubes, openings into the glass cladding tube and the glass capillary tubes away from an end of the hollow core optical fiber preform from which the hollow core optical fiber will be drawn are coupled to one or more tubes in fluid communication with a gas supply. The opening(s) is sealed except for the one or more conduits in fluid communication with the gas supply.

However, there are problems associated with sealing the opening(s) of the glass cladding tube and/or glass capillary tubes around the one or more conduits. For example, sealing the opening of the glass cladding tube around the conduit can lead to cracking of the glass capillary tubes during draw and/or a seal failure during draw. Cracking of the glass capillary tubes during draw is problematic because it may lead to failure of the hollow core optical fiber drawn from the preform. Seal failure during draw is problematic because pressure within the glass cladding tube cannot be adequately controlled without the seal, and uncontrolled pressure within the glass cladding tube may lead to uncontrolled pressure within the glass capillaries, which then may lead to the glass capillaries having dimensions that are not as intended and thus failure of the hollow core optical fiber to function as intended.

The present disclosure addresses those problems, among other problems, with a sealant having a glass composition that exhibits a coefficient of thermal expansion that is similar to the coefficient of thermal expansion that a glass composition of whichever of the glass cladding or glass capillary the sealant is sealing. The similarity in the coefficients of thermal expansion reduces the likelihood that the sealant will crack during draw.

According to a first aspect of the present disclosure, a hollow core optical fiber preform comprises: (a) a preform longitudinal axis extending between a preform first end and a preform second end; (b) a cladding tube comprising (i) a cladding glass composition exhibiting a cladding coefficient of thermal expansion, (ii) a cladding interior through which the preform longitudinal axis extends, (iii) a cladding first end proximate the preform first end, (iv) a cladding second end proximate the preform second end, and (v) a cladding opening at the cladding first end; (c) one or more capillary tubes disposed within the cladding interior and around the preform longitudinal axis, each of the one or capillary tubes comprising (i) a capillary glass composition exhibiting a capillary coefficient of thermal expansion, (ii) a capillary longitudinal axis that is parallel to the preform longitudinal axis, (iii) a capillary interior through which the capillary longitudinal axis extends, (iv) a capillary first end proximate the preform first end, (v) a capillary second end proximate the preform second end, (vi) a capillary opening at the capillary first end, and (vii) a capillary outer surface at a capillary outer radius from the capillary longitudinal axis; (d) an effective core region through which the preform longitudinal axis extends, the effective core region comprising a core radius from the preform longitudinal axis that is tangential to the capillary outer surface of each of the one or more capillary tubes; and (c) a seal at least partially sealing one or more of the cladding opening and the capillary opening of each or some of the one or more capillary tubes, the seal comprising a seal glass composition exhibiting a seal coefficient of thermal expansion, the seal coefficient of thermal expansion within ±10% of the cladding coefficient of thermal expansion or the capillary coefficient of thermal expansion.

According to a second aspect of the present disclosure, the hollow core optical fiber preform of the first aspect is presented, wherein the cladding glass composition and the capillary glass composition are the same.

According to a third aspect of the present disclosure, the hollow core optical fiber preform of any one of the first through second aspects is presented, wherein the cladding glass composition and the capillary glass composition both comprise silica glass.

According to a fourth aspect of the present disclosure, the hollow core optical fiber preform of any one of the first through third aspects is presented, wherein the seal directly contacts and at least partially seals the cladding opening.

According to a fifth aspect of the present disclosure, the hollow core optical fiber preform of any one of the first through fourth aspects is presented, wherein the seal directly contacts and at least partially seals the capillary opening of each of the one or more capillary tubes.

According to a sixth aspect of the present disclosure, the hollow core optical fiber preform of any one of the first through fifth aspects is presented, wherein the seal directly contacts and at least partially seals the cladding opening and the capillary opening of each of the one or more capillary tubes.

According to a seventh aspect of the present disclosure, the hollow core optical fiber preform of any one of the first through sixth aspects is presented, wherein the seal glass composition comprises at least 10 mol % of one or more of Cu₂O and CuO.

According to an eighth aspect of the present disclosure, the hollow core optical fiber preform of any one of the first through seventh aspects is presented, wherein the seal coefficient of thermal expansion is within ±10% of the cladding coefficient of thermal expansion.

According to a ninth aspect of the present disclosure, the hollow core optical fiber preform of any one of the first through eighth aspects is presented, wherein the seal coefficient of thermal expansion is within ±10% of the capillary coefficient of thermal expansion.

According to a tenth aspect of the present disclosure, the hollow core optical fiber preform of any one of the first through ninth aspects is presented, wherein the seal coefficient of thermal expansion is within ±10% of both the cladding coefficient of thermal expansion and the capillary coefficient of thermal expansion.

According to an eleventh aspect of the present disclosure, the hollow core optical fiber preform of any one of the first through tenth aspects is presented, wherein the seal coefficient of thermal expansion is within a range of from 10×10⁻⁸K⁻¹ to 120×10⁻⁸K⁻¹.

According to a twelfth aspect of the present disclosure, the hollow core optical fiber preform of any one of the first through eleventh aspects is presented, wherein (i) the cladding glass composition exhibits a cladding softening point, (ii) the capillary glass composition exhibits a capillary softening point, and (iii) the seal glass composition exhibits a seal softening point.

According to a thirteenth aspect of the present disclosure, the hollow core optical fiber preform of the twelfth aspect is presented, wherein the seal softening point is less than the greater of the cladding softening point and the capillary softening point.

According to a fourteenth aspect of the present disclosure, the hollow core optical fiber preform of the thirteenth aspect is presented, wherein the seal softening point is at least 100° C. less than the greater of the cladding softening point and the capillary softening point.

According to a fifteenth aspect of the present disclosure, the hollow core optical fiber preform of any one of the twelfth through fourteenth aspects is presented, wherein the seal softening point is less than the lesser of the cladding softening point and the capillary softening point.

According to a sixteenth aspect of the present disclosure, the hollow core optical fiber preform of the fifteenth aspect is presented, wherein the seal softening point is at least 100° C. less than the lesser of the cladding softening point and the capillary softening point.

According to a seventeenth aspect of the present disclosure, the hollow core optical fiber preform of any one of the twelfth through sixteenth aspects is presented, wherein the seal softening point is within a range of from 500° C. to 900° C.

According to an eighteenth aspect of the present disclosure, the hollow core optical fiber preform of any one of the first through seventeenth aspects further comprises one or more metal tubes extending through the seal, each of the one or more metal tubes comprising (i) a first tube end disposed outside of the cladding interior, (ii) a second tube end disposed within the cladding interior, and (ii) an outer surface at least partially facing the seal.

According to a nineteenth aspect of the present disclosure, the hollow core optical fiber preform of the eighteenth aspect is presented, wherein (i) the seal at least partially seals the cladding opening, and (ii) the second tube end of at least one of the one or more metal tubes is disposed within the cladding interior and outside of the capillary interior of all of the one or more capillaries.

According to a twentieth aspect of the present disclosure, the hollow core optical fiber preform of the nineteenth aspect further comprises: a silica guide tube disposed within the cladding interior and through which the at least one of the at least one or more metal tubes extends, the silica guide tube separating the at least one of the at least one or more metal tubes from the capillary outer surface of each of the one or more capillaries.

According to a twenty-first aspect of the present disclosure, the hollow core optical fiber preform of the twentieth aspect further comprises: a glass frit disposed on the outer surface of the at least one of the one or more metal tubes between the second tube end and where the outer surface faces the silica guide tube.

According to a twenty-second aspect of the present disclosure, the hollow core optical fiber preform of any one of the eighteenth through twenty-first aspects is presented, wherein (i) the seal at least partially seals the capillary opening of each or some of the one or more capillaries, and (ii) the capillary interior of the least partially sealed ones of the one or more capillaries receives the second tube end of a different one of the one or more metal tubes.

According to a twenty-third aspect of the present disclosure, the hollow core optical fiber preform of the twenty-second aspect further comprises: glass frit disposed between the capillary outer surface of at least one of the at least partially sealed ones of the one or more capillaries and the outer surface of the metal tube disposed therein.

According to a twenty-fourth aspect of the present disclosure, the hollow core optical fiber preform of any one of the eighteenth through twenty-third aspects is presented, wherein each of the one or more metal tubes is in fluid communication with a source of gas.

According to a twenty-fifth aspect of the present disclosure, the hollow core optical fiber preform of any one of the eighteenth through twenty-fourth aspects is presented, wherein the seal further comprises a polymer dispersed within the seal glass composition disposed around the one or more metal tubes.

According to a twenty-sixth aspect of the present disclosure, the hollow core optical fiber preform of any one of the eighteenth through twenty-fifth aspects is presented, wherein each of the one or more metal tubes comprises or is made of stainless steel.

According to a twenty-seventh aspect of the present disclosure, the hollow core optical fiber preform of any one of the first through twenty-sixth aspects is presented, wherein the cladding tube further comprises a cladding outer surface, at least one groove into the cladding outer surface, and a potting compound disposed within the at least one groove.

According to a twenty-eighth aspect of the present disclosure, a method of manufacturing a hollow core optical fiber comprises: a drawing step comprising drawing a hollow core optical fiber from a hollow core optical fiber preform comprising: (a) a preform longitudinal axis extending between a preform first end and a preform second end; (b) a cladding tube comprising (i) a cladding glass composition exhibiting a cladding coefficient of thermal expansion, (ii) a cladding interior through which the preform longitudinal axis extends, (iii) a cladding first end proximate the preform first end, (iv) a cladding second end proximate the preform second end, and (v) a cladding opening at the cladding first end; (c) one or more capillary tubes disposed within the cladding interior and around the preform longitudinal axis, each of the one or capillary tubes comprising (i) a capillary glass composition exhibiting a capillary coefficient of thermal expansion, (ii) a capillary longitudinal axis that is parallel to the preform longitudinal axis, (iii) a capillary interior through which the capillary longitudinal axis extends, (iv) a capillary first end proximate the preform first end, (v) a capillary second end proximate the preform second end, (vi) a capillary opening at the capillary first end, and (vii) a capillary outer surface at a capillary outer radius from the capillary longitudinal axis; (d) an effective core region through which the preform longitudinal axis extends, the effective core region comprising a core radius from the preform longitudinal axis that is tangential to the capillary outer surface of each of the one or more capillary tubes; (c) a seal at least partially sealing one or more of the cladding opening and the capillary opening of each of the one or more capillary tubes, the seal comprising a seal glass composition exhibiting a seal coefficient of thermal expansion, the seal coefficient of thermal expansion within ±10% of the cladding coefficient of thermal expansion or the capillary coefficient of thermal expansion; and (f) one or more metal tubes extending through the seal, each of the one or more metal tubes comprising (i) a first tube end disposed within the cladding interior, (ii) a second tube end disposed outside of the cladding interior, and (iii) an outer surface at least partially facing the seal, wherein, (i) the seal at least partially seals the cladding opening, while the first tube end of at least one of the one or more metal tubes is disposed within the cladding interior and outside of the capillary interior of all of the one or more capillaries, (ii) the seal at least partially seals the capillary opening of each or some of the one or more capillaries, and, the capillary interior of the at least partially sealed ones of the one or more capillaries receives a second end of a different one of the one or more metal tubes, or (iii) both (i) and (ii).

According to a twenty-ninth aspect of the present disclosure, the method of the twenty-eighth aspect further comprises: a gas flow step comprising flowing gas from one or more sources of the gas through the one or more metal tubes.

According to a thirtieth aspect of the present disclosure, the method of any one of the twenty-eighth through twenty-ninth aspects further comprises: a sealing step, occurring before the drawing step, comprising melting a piece of the seal glass composition over (i) the cladding opening, (ii) the capillary opening of each or some of the one or more capillary tubes, or (iii) both (i) and (ii), with the one or more metal tubes extending through the seal glass composition.

According to a thirty-first aspect of the present disclosure, the method of the thirtieth aspect is presented, wherein during the sealing step, the cladding second end is coupled to a vacuum and gas pressure within the cladding interior is reduced to below atmospheric pressure.

According to a thirty-second aspect of the present disclosure, the method of any one of the thirtieth through thirty-first aspects further comprises: a taping step, occurring before the sealing step, comprising adhering a frit tape to the outer surface of each of the one or more metal tubes where the seal will be formed during the sealing step, wherein, during the sealing step, the seal glass composition contacts and causes at least a portion of frit tape to melt.

According to a thirty-third aspect of the present disclosure, the method of the thirty-second is presented, wherein the frit tape comprises polybutylene and the seal glass composition.

According to a thirty-fourth aspect of the present disclosure, the hollow core optical fiber drawn during the drawing step of the method of any one of the twenty-eight through thirty-third aspects.

According to a thirty-fifth aspect of the present disclosure, the hollow core optical fiber of the thirty-fourth aspect is presented, wherein the hollow core optical fiber is an anti-resonant hollow core optical fiber.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

In the Drawings:

FIG. 1 is an elevation view of a hollow core optical fiber preform of the present disclosure, illustrating a cladding tube, capillary tubes within the cladding tube, metal tubes with a first tube end outside of the cladding tube and a second tube end inside of the cladding tube (with some inside of the capillary tubes), and a seal sealing openings into the cladding tube and the capillary tubes around the metal tubes;

FIG. 2 is an exploded perspective view of a portion of the hollow core optical fiber preform, illustrating a silica guide tube surrounding the metal tube inserted in a cladding interior outside of the capillary tubes to separate the metal tube from the capillary tubes;

FIG. 3 is a cross-sectional view of the hollow core optical fiber preform taken along line III-III of FIG. 1, illustrating the capillary tubes arranged azimuthally around a preform longitudinal axis and defining an effective core region;

FIG. 4 is a flow chart of a method of manufacturing the hollow core optical fiber, illustrating a sealing step, a drawing step, a gas flow step, and optionally a taping step;

FIG. 5 is a schematic diagram of the drawing step and the gas flow step, illustrating a furnace heating the hollow core optical fiber preform so that a hollow core optical fiber can be drawn therefrom while gas is caused to flow from one or more sources of gas, through the metal tubes, and capillary interiors of the capillary tubes and the cladding interior (outside of the capillaries) to control outer radii of the capillary tubes and an outer radius of the cladding tube;

FIG. 6 is a schematic diagram of the sealing step, illustrating pieces of a seal glass composition placed on a cladding first end near the cladding opening and the metal tubes, which pieces of seal glass composition are then heated to cause the seal glass composition to flow over the cladding opening and around the metal tubes to seal the cladding opening and the capillary opening of the capillaries;

FIG. 7 is a schematic diagram of the taping step, illustrating frit tape being adhered to an outer tube surface of one of the metal tubes where the outer tube surface is to contact the seal glass composition during the sealing step;

FIG. 8, pertaining to Comparative Example 1, is an image of a borosilicate glass that cracked upon cooling after being subjected to a sealing step to seal a cladding tube of silica, presumably because the coefficient of thermal expansion (CTE) of the borosilicate glass was too different than the CTE of silica;

FIG. 9, pertaining to Example 1, is an image of a cuprous glass that did not crack upon cooling, presumably because the CTE of the silica glass was similar enough to the CTE of silica;

FIG. 10, pertaining to Example 2, is an image showing (a) a piece of a cuprous glass composition, (b) a silica cladding tube with an opening, and (c) the cuprous glass composition having formed a seal over the opening after a sealing step;

FIG. 11, again pertaining to Example 2, is an image showing (a) a source of a metal tube, (b) the metal tube having been removed from the source and placed to extend into the cladding interior of the cladding tube, (c) pieces of the cuprous glass composition set upon the first cladding end of the cladding tube near the cladding opening and the metal tube, and (d) the cuprous glass composition having formed a seal over the opening after a sealing step;

FIG. 12, again pertaining to Example 2, is an image showing (a) a metal tube extending into the cladding interior of the cladding tube and a piece of the cuprous glass composition set upon the first cladding end of the cladding tube near the cladding opening and the metal tube, (b)-(d) the cuprous glass composition flowing over the cladding opening and around the metal tube during a sealing step, and (e) the cuprous glass composition having formed a seal over the opening and around the metal tube after a sealing step;

FIG. 13, again pertaining to Example 2, is an image showing (a) a metal tube, (b) a piece of frit tape, (c) the piece of frit tape adhered onto an outer tube surface of the metal tube, (d) pieces of the cuprous glass composition set upon a first cladding end of a cladding tube near a cladding opening and the metal tube with the frit tape, and (e) the cuprous glass composition having formed a seal over the opening and around the metal tube where the frit tape is after a sealing step;

FIG. 14A, again pertaining to Example 2, is an image showing a metal tube disposed within a cladding interior of a cladding tube through a seal of the cuprous glass composition that had crushed one or more of the capillary tubes also disposed within the cladding interior around the metal tube during a sealing step, presumably because the metal tube had expanded while heated during the sealing step;

FIG. 14B, again pertaining to Example 2, is an image showing a silica guide tube surrounding a metal tube; and

FIG. 14C, again pertaining to Example 2, presents a series of images taken around a hollow core optical fiber perform, illustrating the cladding tube with numerous capillary tubes therein, each receiving a different one of the metal tubes, and the seal of the cuprous glass composition sealing the capillary openings and the cladding opening around the metal tubes, so that the metal tubes can be placed in communication with one or more sources of gas to control gas pressure within each of the capillaries individually as well as the cladding interior outside of the capillary tubes.

### DETAILED DESCRIPTION

Reference will now be made in detail to the present embodiments, examples of which are illustrated in the accompanying drawings. Whenever possible, the same reference numerals will be used throughout the drawings to refer to the same or like parts.

Reference will now be made in detail to the present preferred embodiments, examples of which are illustrated in the accompanying drawings. Whenever possible, the same reference numerals will be used throughout the drawings to refer to the same or like parts.

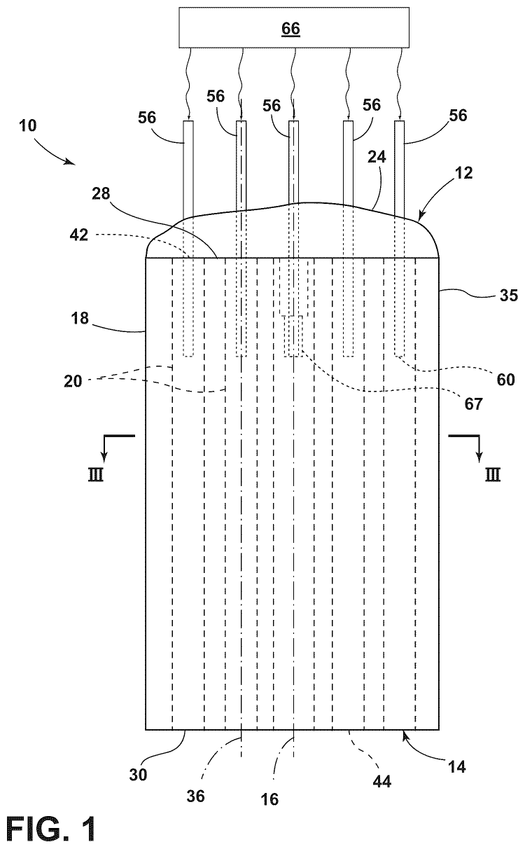

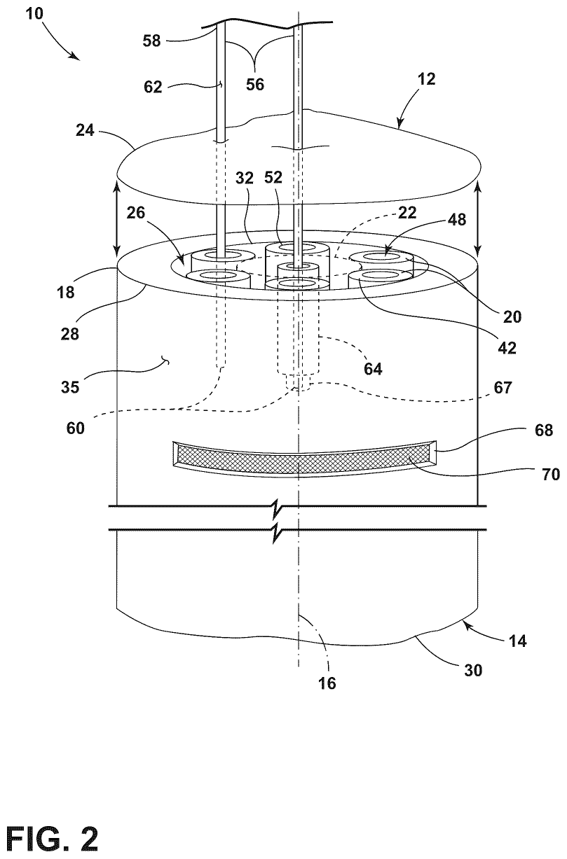

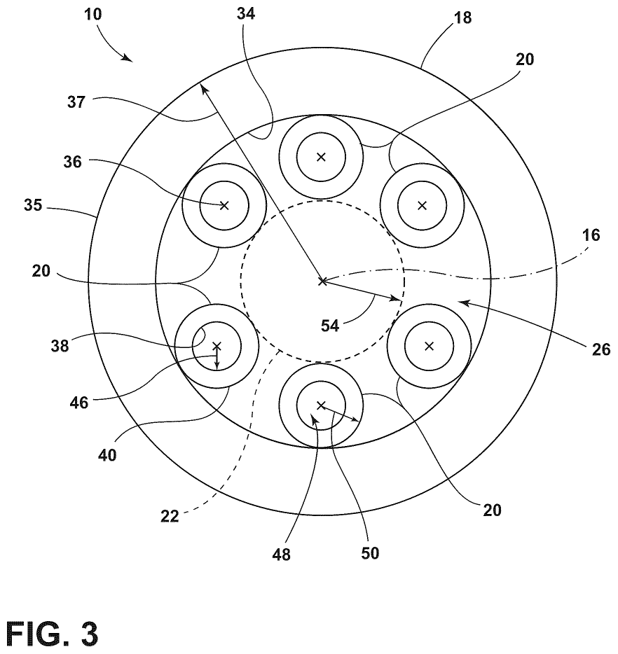

Referring to FIGS. 1-3, a hollow core optical fiber preform 10 includes a preform first end 12, a preform second end 14, and a preform longitudinal axis 16. The preform longitudinal axis 16 extends between the preform first end 12 and the preform second end 14. The hollow core optical fiber preform 10 further includes a cladding tube 18, one or more capillary tubes 20, an effective core region 22 (see FIG. 2), and a seal 24.

The cladding tube 18 includes a cladding glass composition, a cladding interior 26, a cladding first end 28, a cladding second end 30, and a cladding opening 32. The cladding glass composition can be silica glass. The silica glass can be doped (e.g., with fluorine or nitrogen, among other options) so that the cladding glass composition exhibits a viscosity during a subsequent draw step (discussed below) as desired. In addition, the cladding glass composition exhibits a cladding coefficient of thermal expansion.

The preform longitudinal axis 16 extends through the cladding interior 26. The cladding tube 18 includes a cladding inner surface 34 disposed azimuthally around the preform longitudinal axis 16 that defines the cladding interior 26. The cladding first end 28 is proximate the preform first end 12. The cladding second end 30 is proximate the preform second end 14. The cladding opening 32 is at the cladding first end 28. The preform longitudinal axis 16 extends through the cladding opening 32. The cladding tube 18 further includes a cladding outer surface 35. The cladding outer surface 35 is at a cladding outer radius 37.

The one or more capillary tubes 20 are disposed within the cladding interior 26. Each of the one or more capillary tubes 20 includes a capillary longitudinal axis 36, a capillary inner surface 38, a capillary outer surface 40, a capillary first end 42, and a capillary second end 44. The capillary longitudinal axis 36 is parallel to the preform longitudinal axis 16. The capillary inner surface 38 is at a capillary inner radius 46 from the capillary longitudinal axis 36. The capillary inner surface 38 defines a capillary interior 48. The capillary longitudinal axis 36 extends through the capillary interior 48. The capillary outer surface 40 is at a capillary outer radius 50 from the capillary longitudinal axis 36. The capillary first end 42 is disposed proximate the preform first end 12. The capillary second end 44 is disposed proximate the preform second end 14. The one or more capillary tubes 20 are arranged around the preform longitudinal axis 16 such that the capillary outer surface 40 of each of the one or more capillary tubes 20 faces the preform longitudinal axis 16. Each of the one or more capillary tubes 20 can be fused to the cladding inner surface 34, such as proximate the capillary first end 42 and the capillary second end 44. Each of the one or more capillary tubes 20 includes a capillary opening 52 at the capillary first end 42. The capillary opening 52 can be flush with the cladding opening 32.

Each of the one or more capillary tubes 20 includes a capillary glass composition. The capillary glass composition can be silica glass. The silica glass can be doped (e.g., with fluorine or nitrogen, among other options) so that the capillary glass composition exhibits a viscosity during a subsequent draw step as desired. In embodiments, the cladding glass composition and the capillary glass composition are the same, such as both being made of silica glass. The capillary glass composition exhibits a capillary coefficient of thermal expansion.

The effective core region 22 is within a core radius 54. The preform longitudinal axis 16 extends through the effective core region 22 and the core radius 54 is from the preform longitudinal axis 16. The core radius 54 is tangential to the capillary outer surface 40 of each of the one or more capillary tubes 20.

The seal 24 is disposed proximate the preform first end 12. The seal 24 at least partially seals one or more of the cladding opening 32 and the capillary opening 52 of each some of the one or more capillary tubes 20. For example, the seal 24 can directly contact and at least partially seal the cladding opening 32 but not the capillary opening 52 of each of the one or more capillary tubes 20. In such instances, the seal 24 can be bonded to the cladding glass composition at the cladding first end 28. As another example, the seal 24 can directly contact and at least partially seal the capillary opening 52 of each of the one or more capillary tubes 20 but not the cladding opening 32. In such instances, the seal 24 can be bonded to the capillary glass composition at the capillary first end 42 of each of the one or more capillary tubes 20. As yet another example, the seal 24 can directly contact and seal both the cladding opening 32 and the capillary opening 52 of each of the one or more capillary tubes 20. In such instances, the seal 24 can be bonded to the cladding glass composition at the cladding first end 28 and the capillary glass composition at the capillary first end 42 of each of the one or more capillary tubes 20. In other embodiments, the seal 24 can directly contact and at least partially seal the capillary opening 52 of less than all of the one or more capillary tubes 20 while sealing or not sealing capillary opening 52.

The seal 24 includes a seal glass composition. In embodiments, the seal glass composition includes a copper-containing glass, such as a glass including at least 1 mol %, at least 5 mol %, or at least 10 mol % of one or more of Cu₂O and CuO. Such copper-containing glasses may be referred to herein as cuprous glass. In addition to a copper-containing constituent, the seal glass composition can further include glass former constituents, such as one or more of SiO₂, Al₂O₃, B₂O₃, and P₂O₅. The seal glass composition can include a mole percentage of one or more of Cu₂O and CuO of at least 1 mol %, 5 mol %, 10 mol %, 15 mol %, 20 mol %, 25 mol %, 30 mol %, 35 mol %, 40 mol %, 45 mol %, 50 mol %, 55 mol %, 60 mol %, or within any range bound by any two of those values (e.g., from 25 mol % to 40 mol %, from 30 mol % to 50 mol %, and so on).

The seal glass composition exhibits a seal coefficient of thermal expansion. The seal coefficient of thermal expansion is within ±10% of the cladding coefficient of thermal expansion or the capillary coefficient of thermal expansion. For example, if the seal 24 at least partially seals the cladding opening 32, then the seal coefficient of thermal expansion can be within ±10% of the cladding coefficient of thermal expansion. As another example, if the seal 24 at least partially seals the capillary opening 52 of each of the one or more capillary tubes 20, then the seal coefficient of thermal expansion can be within ±10% of the capillary coefficient of thermal expansion. As yet another example, if the seal 24 at least partially seals both the cladding opening 32 and the capillary opening 52 of each of the one or more capillary tubes 20, then the seal coefficient of thermal expansion can be within ±10% of both the cladding coefficient of thermal expansion and the capillary coefficient of thermal expansion. The seal coefficient of thermal expansion can be within ±10%, ±9%, ±8%, ±7%, ±% 6, ±5%, ±4%, ±3%, ±2%, or ±1% of one or more of the cladding coefficient of thermal expansion and the capillary coefficient of thermal expansion. In embodiments, the seal coefficient of thermal expansion is within a range of from 10×10⁻⁸K⁻¹ to 120×10⁻⁸K⁻¹. For example, the seal coefficient of thermal expansion can be 10×10⁻⁸K⁻¹, 20×10⁻⁸K⁻¹, 30×10⁻⁸K⁻¹, 40×10⁻⁸K⁻¹, 50×10⁻⁸K⁻¹, 60×10⁻⁸K⁻¹, 70×10⁻⁸K⁻¹, 80×10⁻⁸K⁻¹, 90×10⁻⁸K⁻¹, 100×10⁻⁸K⁻¹, 110×10⁻⁸K⁻¹, 120×10⁻⁸K⁻¹, or within any range bound by any two of those values (e.g., from 30×10⁻⁸K⁻¹ to 90×10⁻⁸K⁻¹, from 60×10⁻⁸K⁻¹ to 70×10⁻⁸K⁻¹, and so on).

The cladding glass composition exhibits a cladding softening point. As used herein, “softening point” refers to the temperature at which the glass has a viscosity of 10^{7.6} Poise. The capillary glass composition exhibits a capillary softening point. The seal glass composition exhibits a seal softening point. In embodiments, the seal softening point is less than the greater of the cladding softening point and the capillary softening point. For example, the seal softening point is at least 100° C. less than the greater of the cladding softening point and the capillary softening point. In embodiments, the seal softening point is less than the lesser of the cladding softening point and the capillary softening point. For example, the seal softening point can be at least 100° C. less than the lesser of the cladding softening point and the capillary softening point. In embodiments, the seal softening point is within a range of from 500° C. to 900° C. For example, the seal softening point can be 500° C., 510° C., 520° C., 530° C., 540° C., 550° C., 560° C., 570° C., 580° C., 590° C., 600° C., 610° C., 620° C., 630° C., 640° C., 650° C., 660° C., 670° C., 680° C., 690° C., 700° C., 710° C., 720° C., 730° C., 740° C., 750° C., 760° C., 770° C., 780° C., 790° C., 800° C., 810° C., 820° C., 830° C., 840° C., 850° C., 860° C., 870° C., 880° C., 890° C., 900° C., or within any range bound by any two of those values (e.g., from 560° C. to 660° C., from 600° C. to 630° C., and so on).

In embodiments, the hollow core optical fiber preform 10 further includes one or more metal tubes 56. Each of the one or more metal tubes 56 includes a first tube end 58, a second tube end 60, and an outer tube surface 62. The first tube end 58 is disposed outside of the cladding interior 26. The second tube end 60 is disposed within the cladding interior 26. The outer tube surface 62 at least partially faces the seal 24.

In some instances, the second tube end 60 of at least one of the one or more metal tubes 56 is disposed within the cladding interior 26 and outside of the capillary interior 48 of all of the one or more capillary tubes 20. In such instances, the seal 24 at least partially seals the cladding opening 32. Further, in such instances, the hollow core optical fiber preform 10 can further include a silica guide tube 64. The silica guide tube 64 is disposed within the cladding interior 26. The at least one of the one or more metal tubes 56 extends through the silica guide tube 64. The silica guide tube 64 separates the at least one of the one or more metal tubes 56 from the capillary outer surface 40 of each of the one or more capillary tubes 20. The inclusion of the silica guide tube 64 mitigates stress-includes damage to the one or more capillary tubes 20, such as during the formation of the hollow core optical fiber preform 10 or draw of hollow core optical fiber therefrom. The hollow core optical fiber preform 10 can further include glass frit 67. The glass frit 67 is optionally disposed on the outer tube surface 62 of one or more of the at least one of the one or more metal tubes 56 between the second tube end 60 of the at least one of the one or more metal tubes 56 and where the outer tube surface 62 faces the silica guide tube 64. The glass frit 67 can include the seal glass composition. The preform longitudinal axis 16 can extend through the second tube end 60 of the at least one of the one or more metal tubes 56.

In some instances, the seal 24 at least partially seals the capillary opening 52 of two or more of or each of the one or more capillary tubes 20. In such instances, the capillary interior 48 of the at least partially sealed ones of the one or more capillary tubes 20 receives the second tube end 60 of a different one of the one or more metal tubes 56. In addition, glass frit 67 can be disposed between the capillary inner surface 38 of the at least partially sealed ones of the one or more capillary tubes 20 and the outer tube surface 62 of the metal tube 56 disposed therein. The glass frit 67 can include the seal glass composition. The capillary longitudinal axis 36 of each of the one or more capillary tubes 20 can extend through the second tube end 60 of the metal tube 56 disposed therein. Naturally, the cladding interior 26 outside of the one or more capillary tubes 20 and each of the one or more capillary tubes 20 can receive a different one of the one or more metal tubes 56.

Each of the one or more metal tubes 56 is in fluid communication with a one or more sources 66 of gas. The one or more sources 66 of gas in fluid communication with the metal tube 56 with the second tube end 60 disposed within the cladding interior 26 and outside of the capillary interior 48 can be different than the source(s) 66 of gas in fluid communication with the one or more metal tubes 56 with the second tube end 60 disposed within the capillary interior 48 of the one or more capillary tubes 20. Each capillary interior 48 can be in fluid communication with a different one or more sources 66 of gas via a different one of the one or more metal tubes 56.

In embodiments, the seal 24 further includes a polymer dispersed within the seal glass composition disposed around the one or more metal tubes 56. For example, the polymer can be polybutylene carbonate. Other polymers are envisioned.

In embodiments, each of one or more metal tubes 56 includes or is made of metal. Stainless steel is a suitable metal. Other metals are envisioned.

In embodiments, the cladding tube 18 further includes at least one groove 68 and a potting compound 70. The at least one groove 68 is formed into the cladding outer surface 35. The at least one groove 68 can be proximate the cladding first end 28. The potting compound 70 is disposed within the at least one groove 68. During draw of the hollow core optical fiber from the hollow core optical fiber preform 10, the seal 24 can reach temperatures above 600° C. Such a temperature can soften the seal 24 and cause the seal 24 to break when pressure is applied to the cladding interior 26 or capillary interior 48 of the one or more capillary tubes 20. Such a temperature can further cause the one or more metal tubes 56 to bend. The potting compound 70, which can be a low CTE potting compound 70, within the at least one groove 68 scatters the light that comes from the glowing-hot region of the hollow core optical fiber preform 10 during draw. The scattering of the light prevents the light from reaching the seal 24 and raising the temperature of the seal 24. The integrity of the seal 24 thus remains throughout the draw. An example potting compound 70 is Durapot™ 821 (Cotronics Corp., Brooklyn NY USA).

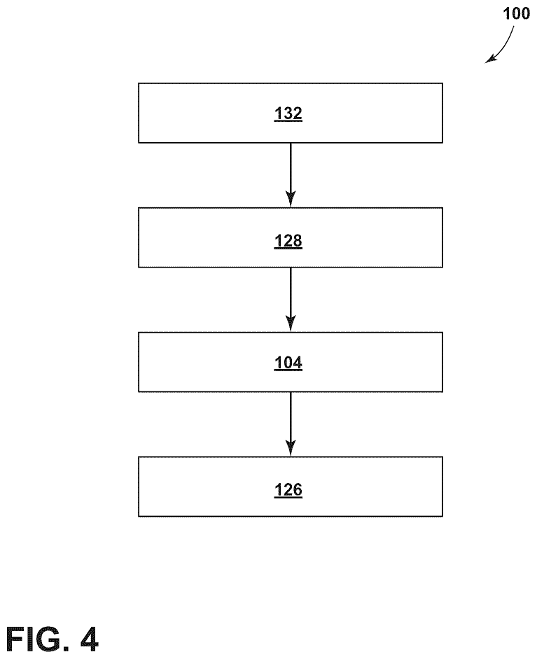

Referring now to FIGS. 4-7, a method 100 of manufacturing a hollow core optical fiber 102 is herein disclosed. The method 100 includes a drawing step 104. The drawing step 104 includes drawing the hollow core optical fiber 102 from any of the embodiments of the hollow core optical fiber preform 10 disclosed herein. The hollow core optical fiber 102 can be an anti-resonant hollow core optical fiber 102.

As described, the hollow core optical fiber 102 can be configured so that gas pressure within the cladding interior 26 outside of the one or more capillary tubes 20 can be controlled via one of the metal tubes 56. In such instances, the seal 24 at least partially seals the cladding opening 32, and second tube end 60 of at least one of the one or more metal tubes 56 is disposed within the cladding interior 26 and outside of the capillary interior 48 of all of the one or more capillary tubes 20. Alternatively, the hollow core optical fiber 102 can be configured so that gas pressure within the capillary interior 48 of each or some of the one or more capillary tubes 20 can be individually or collectively controlled via one or more metal tubes 56 of equal or lesser number to the one or more capillary tubes 20. In such instances, the seal 24 at least partially seals the capillary opening 52 of each or some of the one or more capillary tubes 20, and the capillary interior 48 of each or some of the one or more capillary tubes 20 receives the first end 60 of a different one of the one or more metal tubes 56. Further alternatively, the hollow core optical fiber 102 can be configured (i) so that gas pressure within the cladding interior 26 outside of the one or more capillary tubes 20 can be controlled via one of the metal tubes 56 and (ii) so that gas pressure within the capillary interior 48 of each or some of the one or more capillary tubes 20 can be individually or collectively controlled via one or more metal tubes 56 of equal or lesser number to the one or more capillary tubes 20. In such instances, the seal 24 at least partially seals both the cladding opening 32 and the capillary opening 52 of each or some of the one or more capillary tubes 20, and the second tube end 60 of one of the one or more metal tubes 56 is disposed in the cladding interior 26 and the second tube end 60 of different ones of the one or more metal tubes 56 is disposed in a different capillary interior 48 of each or some of the one or more capillary tubes 20.

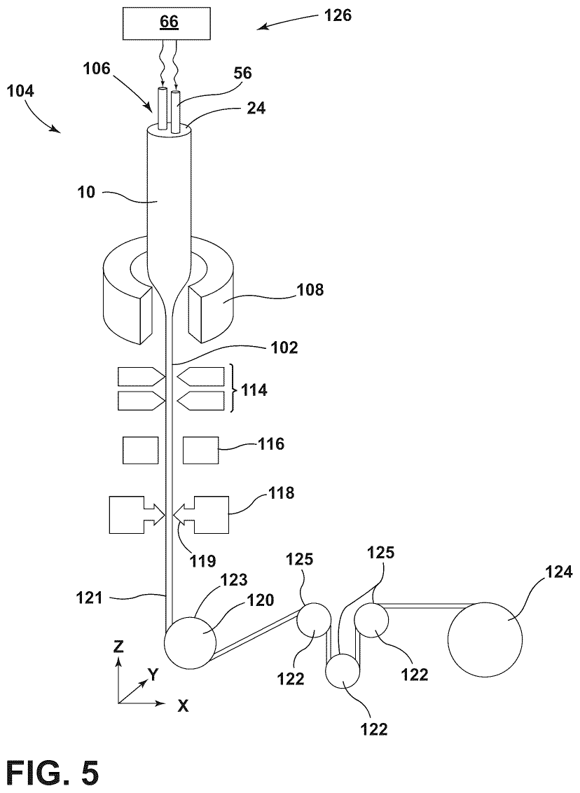

The drawing step 104 can be performed using a draw system 106 (see FIG. 5). The draw system 106 can include a furnace 108 for heating the hollow core optical fiber preform 10 to melt the cladding tube 18 and the one or more capillary tubes 20. The furnace 108 can be disposed in a draw tower. In embodiments, the furnace 108 includes a heater such that the hollow core optical fiber preform 10 is consumed and drawn into the hollow core optical fiber 102 as it is lowered towards the heater 112. The draw system 106 can further include non-contact measurement sensors 114 for measuring the size (e.g., outer radius) of the hollow core optical fiber 102 that exits the furnace 108. A cooling station 116 can reside downstream of the measurement sensors 114 and is configured to cool the hollow core optical fiber 102. A coating station 118 can reside downstream of the cooling station 116. The coating station 118 is configured to deposit a protective coating material 119 onto the hollow core optical fiber 102 to form a coated hollow core optical fiber 121. A tensioner 120 resides downstream of the coating station 118. The tensioner 120 has a surface 123 that pulls (draws) the coated hollow core optical fiber 121. A set of guide wheels 122 with respective surfaces 125 resides downstream of the tensioner 120. The guide wheels 122 serve to guide the coated hollow core optical fiber 102 to a fiber take-up spool 124 to store the coated hollow core optical fiber 102.

In embodiments, the method 100 further includes a gas flow step 126. The gas flow step 126 further includes flowing gas from the one or more sources 66 of gas through the one or more metal tubes 56. The gas enters the first tube end 58 of each of the one or more metal tubes 56 and exits the second tube end 60 to flow into (i) the cladding interior 26 or (ii) the capillary interior 48 of each or some of the one or more capillary tubes 20, or (iii) both (i) and (ii), depending on how the hollow core optical fiber preform 10 is configured. The flow of the gas is controlled to control the cladding outer radius 37 of the cladding tube 18 and/or the capillary outer radius 50 of each or some of the one or more capillary tubes 20 of the hollow core optical fiber 102. The gas flow step 126 can occur simultaneously with the performance of the drawing step 104.

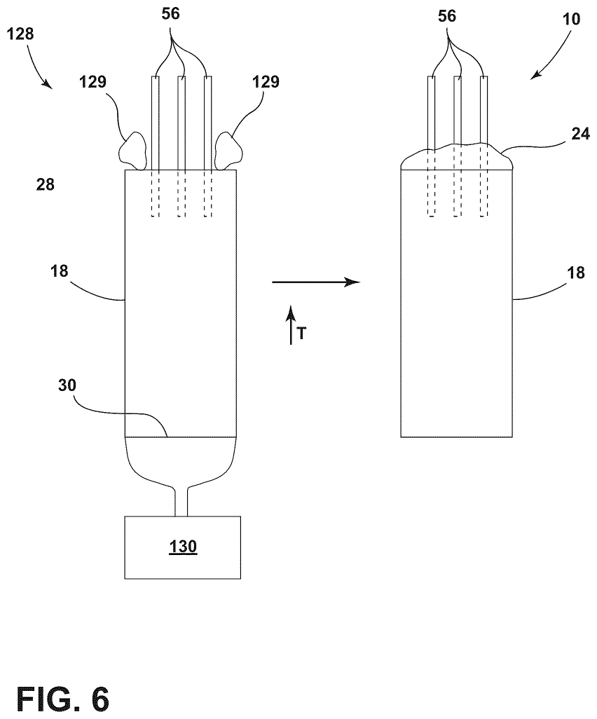

In embodiments, the method 100 further includes a sealing step 128 (see FIG. 6). The sealing step 128 occurs before the drawing step 104 and the gas flow step 126. The sealing step 128 includes melting one or more pieces 129 of the seal glass composition over (i) the cladding opening 32, (ii) the capillary opening 52 of each or some of the one or more capillary tubes 20, or (iii) both (i) and (ii), with the one or more metal tubes 56 extending through the seal glass composition. A furnace, such as an inductive furnace, can be utilized to melt the seal glass composition. In short, the sealing step 128 forms the seal 24 over the cladding opening 32 and/or the capillary opening 52 of each or some of the one or more capillary tubes 20 while allowing fluid communication between the one or more sources 66 of gas, through the one or more metal tubes 56, and the cladding interior 26 and/or the capillary interior 48 of each or some of the one or more capillary tubes 20, as the case may be.

In embodiments, during the sealing step 128, the cladding second end 30 is coupled to a vacuum 130 and gas pressure within the cladding interior 26 is reduced to below atmospheric pressure. Reducing the gas pressure within the cladding interior 26 facilitates the flow of the molten seal glass composition around the one or more metal tubes 56 and partially into the cladding interior 26.

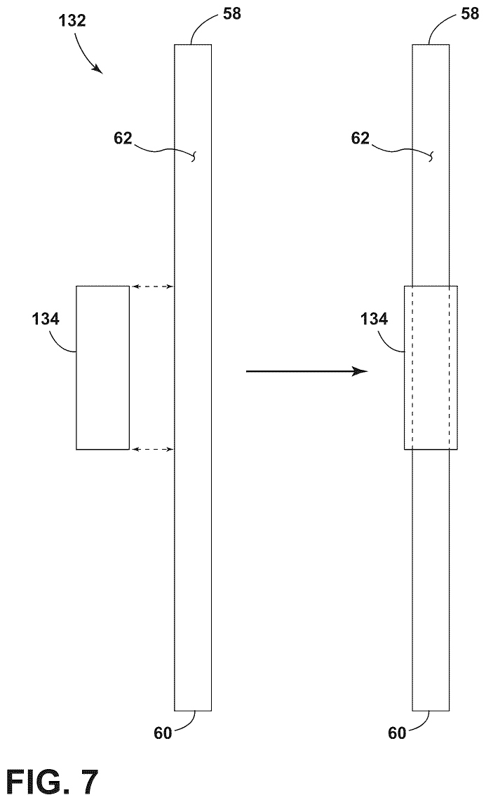

In embodiments, the method 100 further includes a taping step 132 (see FIG. 7). The taping step 132 occurs before the sealing step 128. The taping step 132 includes adhering a frit tape 134 to the outer tube surface 62 of each of the one or more metal tubes 56 where the seal 24 will be formed during the sealing step 128. During the sealing step 128, the seal glass composition contacts and causes at least a portion of frit tape 134 to melt. The melting of the frit tape 134 facilitates the formation of the seal 24 around the one or more metal tubes 56. The frit tape 134 can include the polymer mentioned above with the seal glass composition. Melting of the frit tape 134 thus results in the seal 24 including both the seal glass composition and the polymer proximate the one or more metal tubes 56.

### EXAMPLES

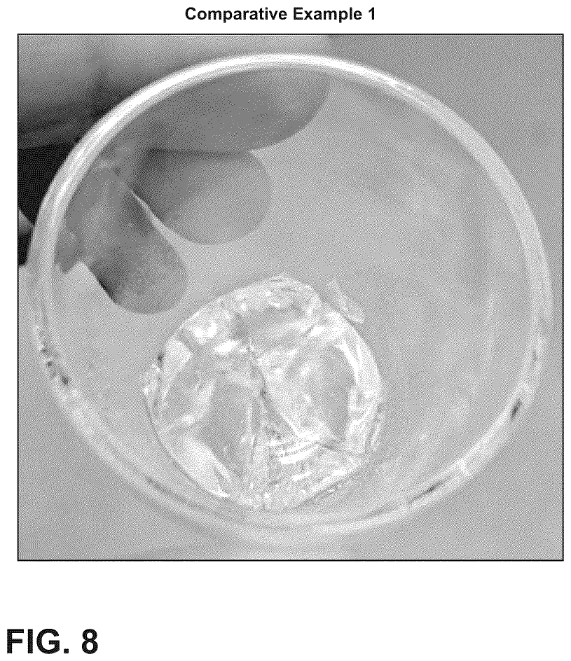

Comparative Example 1—For Comparative Example 1, a borosilicate glass composition was heated to its softening temperature and applied over a cladding opening of a cladding tube in an attempt to form a seal over the cladding opening. The cladding tube was made of silica. The borosilicate glass, at its softening temperature, fused to the cladding tube. However, upon cooling, the borosilicate glass cracked. It was hypothesized that the borosilicate glass cracked because a coefficient of thermal expansion (CTE) that the borosilicate glass exhibits is too different than a CTE that the cladding tube of silica exhibits. A picture of the cracked borosilicate glass is reproduced at FIG. 8.

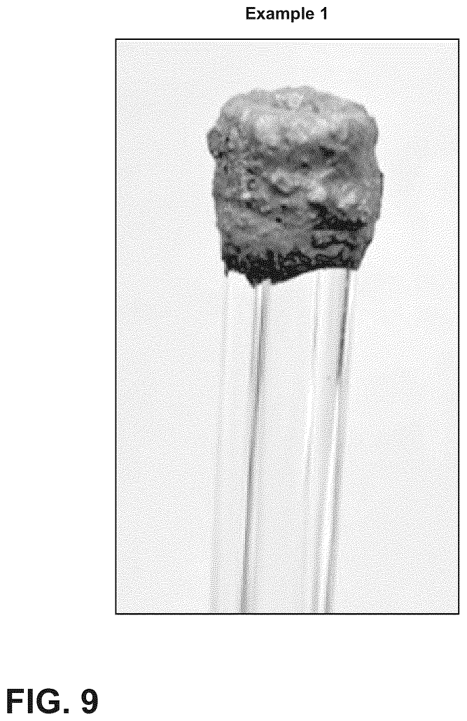

Example 1—For Example 1, a cuprous glass composition was heated to a molten state. A cladding opening of a cladding tube was then dipped into the molten cuprous glass in an attempt to form a seal over the cladding opening. The cladding tube was made of silica. The cuprous glass had a composition of 60 mol % Cu₂O and 40 mol % P₂O₅. The cuprous glass, at its softening temperature, fused to the cladding tube and formed a seal. Upon cooling, the cuprous glass composition did not crack. The lack of cracking upon cooling indicates CTE computability between the CTE of the cuprous glass composition and the CTE of silica. However, the cuprous glass composition did present suboptimal glass stability and crystallized upon cooling. A picture of the cuprous glass composition as a seal over the cladding tube is reproduced at FIG. 9.

Examples 2A-2D—The glass compositions of Examples 2A-2D in Table 1 below were considered for use as a sealing glass composition. In Table 1, “Anneal Point” refers to the temperature at which the glass has a viscosity of 10^{13.0} Poise, “Strain Point” refers to the temperature at which the glass has a viscosity of 10^{14.5} Poise, and “Softening Point” refers to the temperature at which the glass has a viscosity of 10^{7.6} Poise.

TABLE 1

| | Ex. 2A | Ex. 2B | Ex. 2C | Ex. 2D |
|---|---|---|---|---|
| Constituent | (mol %) | (mol %) | (mol %) | (mol %) |
| Cu₂O | 17.57 | 17.22 | | 16.67 |
| CuO | | | 29.89 | |
| Al₂O₃ | 14.19 | 11.92 | 12.07 | 16.67 |
| AlF₃ | | 3.97 | | |
| B₂O₃ | 3.38 | 3.31 | 2.87 | |
| SiO₂ | 64.86 | 63.58 | 55.17 | 66.67 |
| Properties | | | | |
| Density (g/cm³) | 2.915 | 2.922 | 2.893 | 2.923 |
| CTE (×10E−07/° K) | 5.2 | 7 | 11 | 11.5 |
| Avg 50-475° C. | | | | |
| Anneal Point (° C.) | 549 | 489 | 573 | 607 |
| Strain Point (° C.) | 514 | 465 | 540 | 575 |
| Softening Point (° C.) | 831 | 800 | 775 | 800 |

All of the glass compositions include a copper-containing constituent. The cuprous glass compositions exhibit a CTE compatibility to silica and soften at a lower temperature than silica. The cuprous glasses were believed to be suitable as seal glass compositions of the present disclosure.

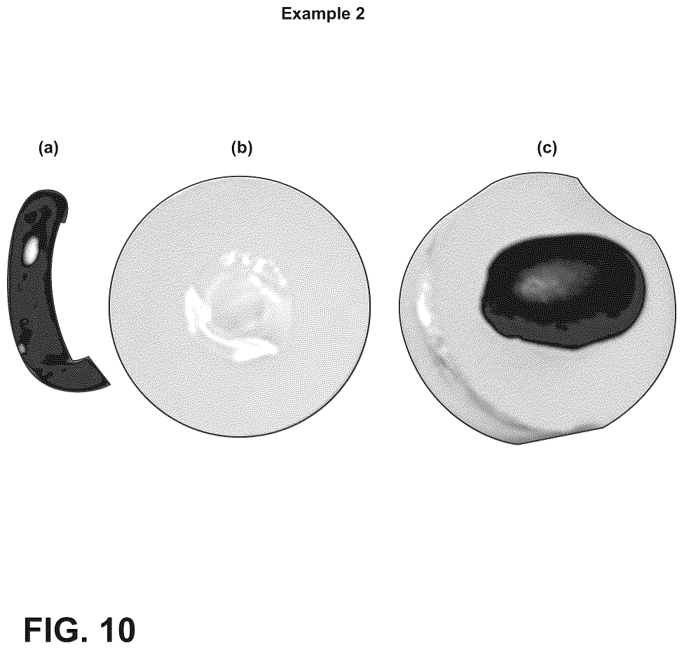

A piece of cuprous glass was then formed from one of the compositions from Table 1 above. The piece was then placed on a first cladding end of a cladding tube made of silica to form a workpiece. The workpiece was then placed in a furnace to make the piece of cuprous glass flow over the opening of the cladding tube. The workpiece was then allowed to cool to room temperature. The cuprous glass had hardened to seal the opening and no cracks formed. The absence of cracks indicated that the CTEs of the cuprous glass and the silica glass were suitable similar to permit cofiring. Pictures of (a) the piece of cuprous glass, (b) the cladding tube of silica, and (c) the cuprous glass seal over the opening of the cladding tube are produced at FIG. 10.

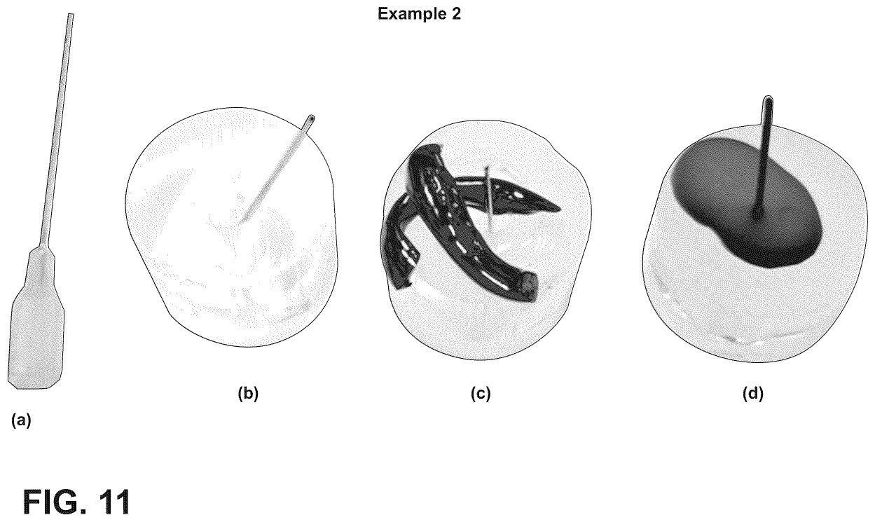

The sealing capability of the same cuprous glass composition with a metal tube was also investigated. In reference to the image reproduced at FIG. 11, a metal tube of stainless steel (a) was cut and placed in cladding tube of silica (b). Pieces of the cuprous glass composition were placed on top of the cladding tube and proximate the metal tube (c) to form a workpiece. The workpiece was then placed in a furnace. The furnace was nitrogen-purged to avoid oxidization of the metal tube. The temperature within the furnace was raised to 700° C. The cuprous glass softened and flowed over the cladding opening of the cladding tube and formed a seal over the cladding open around the metal tube (d). The integrity of the seal was tested via water immersion and pressurization. With this test the appearance of bubbles in the water is indicative of a compromised seal. No bubbles appeared for pressure values less than 7 psi. For pressure values greater than 7 psi, leakage was apparent at the interface between the metal tube and the seal of cuprous glass. For some samples, the interface between the metal tube and the cuprous glass seal remained sealed even beyond 11.5 psi. Since the pressure in the capillary tubes during a drawing step does not exceed 1 psi, the cuprous glass seal is robust enough for active control of gas flow and pressurization.

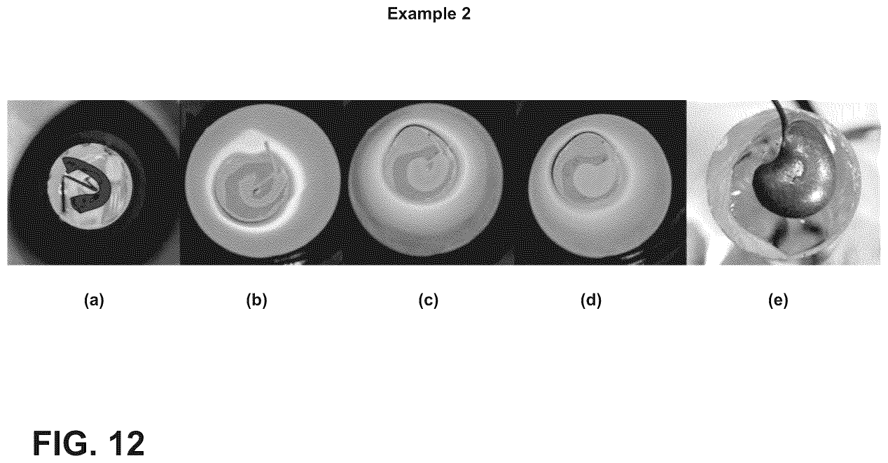

The process of the flow, while softening, of the cuprous glass composition over the cladding open was investigated more closely. In reference to FIG. 12, pieces of the cuprous glass composition were again placed onto the cladding first end of the cladding tube of silica proximate the cladding opening, out of which a metal tube was protruding, to form a workpiece. See FIG. 12(a). The workpiece was then placed in a vertical inductive furnace. The vertical inductive furnace was constantly purged with nitrogen, and the temperature was raised until the cuprous glass flowed over the cladding opening and around the metal tube. See FIG. 12(b)-(d). The workpiece was then left to cool to room temperature.

The images captured during the inductive heating revealed that the flow of the cuprous glass around the metal tube was suboptimal. Suboptimal flow of the seal glass composition magnifies when trying to seal the cladding opening with multiple capillary openings and metal tubes extending into each of the capillary openings. For example, the multiple metal tubes block the seal glass composition from flowing to the cladding longitudinal axis over the cladding opening.

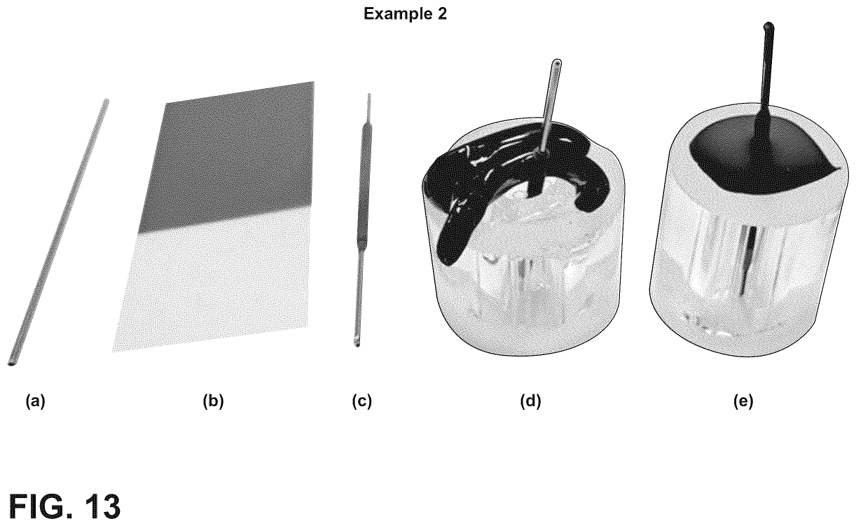

In reference to FIG. 13, the effect of incorporating a glass frit around the metal tube on the flowability of the seal glass composition was explored. A metal tube was obtained from a source of the metal tube. See FIG. 13(a). A tape of glass frit was obtained. See FIG. 13(b). The glass frit was a composite of polybutylene carbonate and cuprous glass. The tape of glass frit was then placed around the outer surface of the metal tube. See FIG. 13(c). The metal tube, with the tape of glass frit adhered thereto, was placed into a cladding opening of a cladding tube of silica. Pieces of the cuprous glass composition was then placed onto the first end of the cladding tube proximate the cladding opening and the metal tube to form a workpiece. See FIG. 13(d). The workpiece was then placed into a nitrogen-purged furnace to avoid oxidization of the metal tube. The temperature within the furnace was then raised to 700° C. within about 8 minutes. The furnace was turned off when the temperature reached 700° C., and then left to cool to room temperature. While in the furnace, the cuprous glass flowed over the cladding opening around the metal tube. FIG. 13(e). The incorporation of the frit tape improved wettability of the outer surface of the metal tube and facilitated flow of the cuprous glass around the metal tube, improving the formation of the seal.

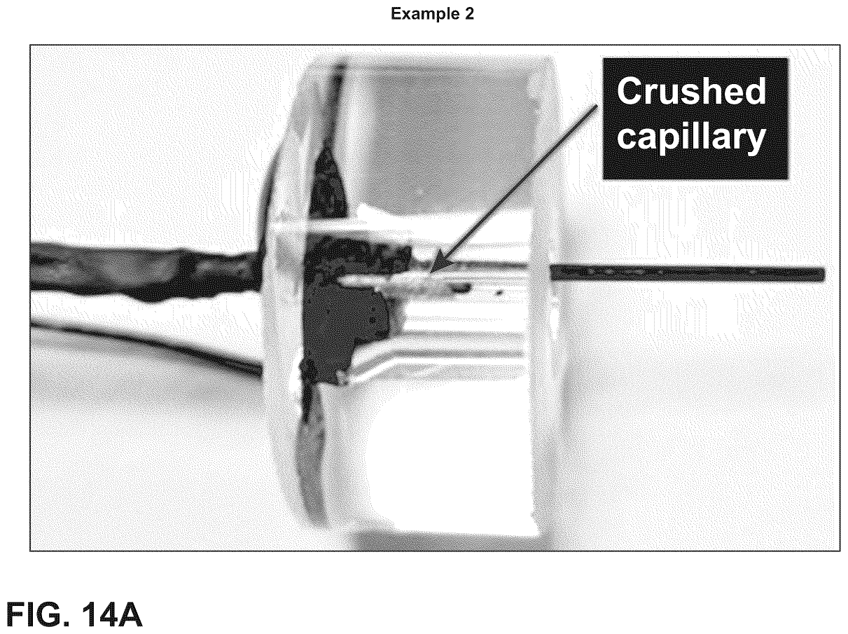

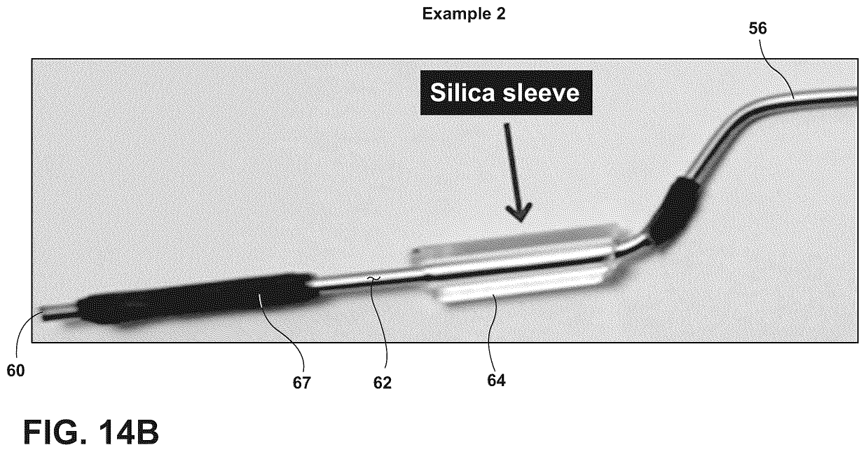

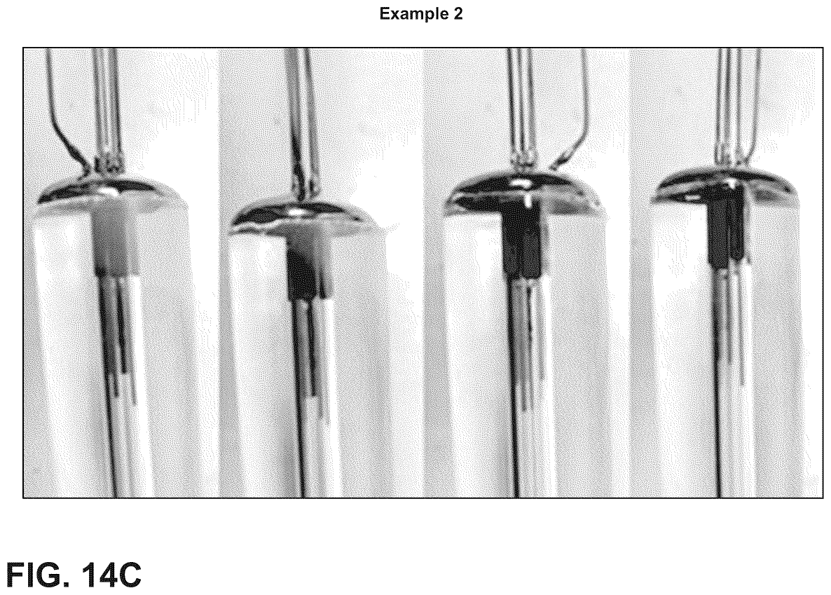

In reference to FIGS. 14A-C, the incorporation of the silica guide tube for the metal tube within the cladding interior in the presence of the capillaries also within the cladding interior was investigated. A workpiece was made with six capillaries disposed within a cladding interior, a metal tube protruding into the cladding interior outside of the capillaries, and pieces of cuprous glass proximate the cladding opening and metal tube. Upon heating of the workpiece to form a seal of the cuprous glass over the cladding opening, one or more of the capillaries cracked. It is hypothesized that stainless steel (from which the metal tube was made) has a CTE an order of magnitude higher than the CTE of silica. Thus, the metal tube expanded and crushed the one or more capillaries. See FIG. 14A.

The same workpiece as the paragraph above was again made, with the workpiece further including a silica guide tube through which the metal tube in communication with the cladding interior extended. The silica guide tube separated the metal tube from the six capillaries disposed around the metal tube within the cladding interior. See FIG. 14B. This particular silica guide tube had an inner diameter of 1.1 mm and an outer diameter of 3 mm. The metal tube had an outer diameter of 1 mm. A layer of cuprous glass frit was added near the second end of the metal tube to prevent the silica guide tube from falling off the metal tube when the workpiece was hung vertically. The workpiece was heated to form the seal of the cuprous glass over the cladding open. None of the capillaries were damaged. See FIG. 14C. In addition, a pressure-based leak test showed that each of the capillaries and the centerline were hermetically sealed.

It will be apparent to those skilled in the art that various modifications and variations can be made without departing from the spirit or scope of the claims.

It will be apparent to those skilled in the art that various modifications and variations can be made without departing from the spirit or scope of the claims.

What is claimed is:

1. A hollow core optical fiber preform comprising:
a preform longitudinal axis extending between a preform first end and a preform second end;
a cladding tube comprising (i) a cladding glass composition exhibiting a cladding coefficient of thermal expansion, (ii) a cladding interior through which the preform longitudinal axis extends, (iii) a cladding first end proximate the preform first end, (iv) a cladding second end proximate the preform second end, and (v) a cladding opening at the cladding first end;
one or more capillary tubes disposed within the cladding interior and around the preform longitudinal axis, each of the one or capillary tubes comprising (i) a capillary glass composition exhibiting a capillary coefficient of thermal expansion, (ii) a capillary longitudinal axis that is parallel to the preform longitudinal axis, (iii) a capillary interior through which the capillary longitudinal axis extends, (iv) a capillary first end proximate the preform first end, (v) a capillary second end proximate the preform second end, (vi) a capillary opening at the capillary first end, and (vii) a capillary outer surface at a capillary outer radius from the capillary longitudinal axis;
an effective core region through which the preform longitudinal axis extends, the effective core region comprising a core radius from the preform longitudinal axis that is tangential to the capillary outer surface of each of the one or more capillary tubes; and
a seal at least partially sealing one or more of the cladding opening and the capillary opening of each or some of the one or more capillary tubes, the seal comprising a seal glass composition exhibiting a seal coefficient of thermal expansion, the seal coefficient of thermal expansion within ±10% of the cladding coefficient of thermal expansion or the capillary coefficient of thermal expansion.

2. The hollow core optical fiber preform of claim 1, wherein the cladding glass composition and the capillary glass composition are the same.

3. The hollow core optical fiber preform of claim 1, wherein the seal directly contacts and at least partially seals the cladding opening.

4. The hollow core optical fiber preform of claim 1, wherein the seal directly contacts and at least partially seals the capillary opening of each of the one or more capillary tubes.

5. The hollow core optical fiber preform of claim 1, wherein the seal glass composition comprises at least 10 mol % of one or more of Cu₂O and CuO.

6. The hollow core optical fiber preform of claim 1, wherein the seal coefficient of thermal expansion is within ±10% of the cladding coefficient of thermal expansion.

7. The hollow core optical fiber preform of claim 1, wherein the seal coefficient of thermal expansion is within ±10% of the capillary coefficient of thermal expansion.

8. The hollow core optical fiber preform of claim 1, wherein the seal coefficient of thermal expansion is within a range of from 10×10⁻⁸ K⁻¹ to 120×10⁻⁸ K⁻¹.

9. The hollow core optical fiber preform of claim 1, wherein
the cladding glass composition exhibits a cladding softening point,
the capillary glass composition exhibits a capillary softening point,
the seal glass composition exhibits a seal softening point; and
the seal softening point is less than the cladding softening point or the capillary softening point.

10. The hollow core optical fiber preform of claim 1 further comprising:
one or more metal tubes extending through the seal, each of the one or more metal tubes comprising (i) a first tube end disposed outside of the cladding interior, (ii) a second tube end disposed within the cladding interior, and (ii) an outer surface at least partially facing the seal.

11. The hollow core optical fiber preform of claim 10, wherein
the seal at least partially seals the cladding opening, and
the second tube end of at least one of the one or more metal tubes is disposed within the cladding interior and outside of the capillary interior of all of the one or more capillaries.

12. The hollow core optical fiber preform of claim 11 further comprising:
a silica guide tube disposed within the cladding interior and through which the at least one of the at least one or more metal tubes extends, the silica guide tube separating the at least one of the at least one or more metal tubes from the capillary outer surface of each of the one or more capillaries.

13. The hollow core optical fiber preform of claim 12 further comprising:
a glass frit disposed on the outer surface of the at least one of the one or more metal tubes between the second tube end and where the outer surface faces the silica guide tube.

14. The hollow core optical fiber preform of claim 10, wherein
the seal at least partially seals the capillary opening of each or some of the one or more capillaries, and
the capillary interior of the at least partially sealed ones of the one or more capillaries receives the second tube end of a different one of the one or more metal tubes.

15. The hollow core optical fiber preform of claim 14 further comprising:
glass frit disposed between the capillary outer surface of at least one of the at least partially sealed ones of the one or more capillaries and the outer surface of the metal tube disposed therein.

16. The hollow core optical fiber preform of claim 10, wherein each of the one or more metal tubes is in fluid communication with a source of gas.

17. The hollow core optical fiber preform of claim 10, wherein the seal further comprises a polymer dispersed within the seal glass composition disposed around the one or metal tubes.

18. A method of manufacturing a hollow core optical fiber comprising:
a drawing step comprising drawing a hollow core optical fiber from a hollow core optical fiber preform comprising:
a preform longitudinal axis extending between a preform first end and a preform second end;
a cladding tube comprising (i) a cladding glass composition exhibiting a cladding coefficient of thermal expansion, (ii) a cladding interior through which the preform longitudinal axis extends, (iii) a cladding first end proximate the preform first end, (iv) a cladding second end proximate the preform second end, and (v) a cladding opening at the cladding first end;
one or more capillary tubes disposed within the cladding interior and around the preform longitudinal axis, each of the one or capillary tubes comprising (i) a capillary glass composition exhibiting a capillary coefficient of thermal expansion, (ii) a capillary longitudinal axis that is parallel to the preform longitudinal axis, (iii) a capillary interior through which the capillary longitudinal axis extends, (iv) a capillary first end proximate the preform first end, (v) a capillary second end proximate the preform second end, (vi) a capillary opening at the capillary first end, and (vii) a capillary outer surface at a capillary outer radius from the capillary longitudinal axis;
an effective core region through which the preform longitudinal axis extends, the effective core region comprising a core radius from the preform longitudinal axis that is tangential to the capillary outer surface of each of the one or more capillary tubes;
a seal at least partially sealing one or more of the cladding opening and the capillary opening of each or some of the one or more capillary tubes, the seal comprising a seal glass composition exhibiting a seal coefficient of thermal expansion, the seal coefficient of thermal expansion within ±10% of the cladding coefficient of thermal expansion or the capillary coefficient of thermal expansion; and
one or more metal tubes extending through the seal, each of the one or more metal tubes comprising (i) a first tube end disposed within the cladding interior, (ii) a second tube end dispose outside of the cladding interior, and (iii) an outer surface at least partially facing the seal,
wherein, (i) the seal at least partially seals the cladding opening, and the first tube end of at least one of the one or more metal tubes is disposed within the cladding interior and outside of the capillary interior of all of the one or more capillaries, (ii) the seal at least partially seals the capillary opening of each or some of the one or more capillaries, and, the capillary interior of the at least partially sealed ones of the one or more capillaries receives a second end of a different one of the one or more metal tubes, or (iii) both (i) and (ii).

19. The method of claim 18 further comprising:
a gas flow step comprising flowing gas from one or more sources of the gas through the one or more metal tubes.

20. The method of claim 18 further comprising:
a sealing step, occurring before the drawing step, comprising melting a piece of the seal glass composition over (i) the cladding opening, (ii) the capillary opening of each or some of the one or more capillary tubes, or (iii) both (i) and (ii), with the one or more metal tubes extending through the seal glass composition.
